(19) United States
(12) Patent Application Publication
(10) Pub. No.: US 2002/0133915 A1
(43) Pub. Date: Sep. 26, 2002

(54) Spring band element

(75) Inventors: Heinz Hendrichs, Finnentrop (DE); Franz Hucker, Lennestadt (DE); Mario Hufnagel, Attendorn (DE)

Correspondence Address: NIXON PEABODY, LLP, 8180 GREENSBORO DRIVE, SUITE 800, MCLEAN, VA, 22102, US

(73) Assignee: Muhr und Bender KG, Attendorn (DE)

(21) Appl. No.: 10/085,144

(22) Filed: Mar. 1, 2002

(30) Foreign Application Priority Data
Mar. 1, 2001 (DE) 101 10 020.5
Mar. 19, 2001 (DE) 101 13 444.4

(51) Int. Cl. F16L 33/00

(52) U.S. Cl. 24/20 R

(57) ABSTRACT

A raised spring band ring which includes a spring band which annularly surrounds one end of a hose, and two clamp ends which overlap one another and which run essentially in the peripheral direction of the spring band ring. The spring band ring when, in the clamping state, has a certain first diameter, and can be spread against its own spring force using a clamping tool to a second larger diameter. Additionally, the spring band ring has a smaller demand for installation space because the clamp ends, when in the clamped state, do not project radially outward from the round spring band.

### BACKGROUND OF THE INVENTION

1. Field of the Invention

The invention relates to a spring band element with a spring band which surrounds one end of a hose annularly and has two clamp ends which overlap one another and which run essentially in the peripheral direction, such that in the clamping state the spring band element has a certain first diameter; while in the clamped state the spring band element can be spread against its own spring force using a clamping tool to a second larger diameter in the spread state.

2. Description of Related Art

Spring band elements have been known for years in the form of spring band clamps in various embodiments, as shown in U.S. Pat. Nos. 4,773,129, 4,930,192 and 5,615,457, and German Patent No. 43 05 649. Using these spring band clamps, a pressure-tight seat of hose ends on the pipe unions of the cooling system of a motor vehicle engine is ensured. These spring band clamps in the clamped state have a certain inside diameter and can be spread to a much greater diameter using a clamping tool which engages the clamp ends against the inherent spring force of the spring band, i.e., in the spread state, in which the spring band clamp has an inside diameter which is greater than the outside diameter of the hose end and thus can be easily moved over the hose end which is to be slipped onto the pipe union that is to be the respective mounting site. The pressure-tight seat of one hose end on the pipe union is ensured by the inherent elasticity of the hose end, and by the spring force of the spring band clamp, i.e. of the spring band, since the spring band clamp in the clamped state is slightly widened against its own spring force.

In the known spring band clamps, the clamp ends are constructed to project radially outward from the spring band. On the one hand, this has the advantage that the clamp ends are easily accessible for engaging the clamping tool, on the other hand they enable a retaining element to be mounted which holds the spring band clamp in the opened state.

In the prior art, a host of proposals have been advanced for constructing the clamp ends of the retaining element to make as simple as possible for the mechanic the installation of the spring band clamp in the engine compartment of a motor vehicle, and for making the retaining element easily and safely removable. The defect in the known spring band clamps, however, is that due to the radially projecting clamp ends and the retaining element which extends over the clamp ends the need for installation space is relatively large compared to the diameter of the spring band clamp. Moreover, there is the danger that components which are adjacent to the spring band clamp will be damaged by the radially projecting clamp ends, especially when the pipe union on which the spring band clamp is attached, or the adjacent components, cause vibrations when the vehicle is being operated.

### SUMMARY OF THE INVENTION

The object of the invention is to devise a spring band element of the initially mentioned type which has only a small demand for installation space and thus is made such that damage to adjacent components by the spring band element is avoided.

The spring band element of the invention, in which the aforementioned object is achieved, is characterized by clamp ends, when in the clamped state, not projecting radially outward from the spring band. By abandoning the radially projecting clamp ends, a spring band ring with minimum dimensions is available which thus also has only a minimum demand for installation space. The embodiments of the invention which appear rather simple in retrospect not only reduce the outside diameter of the spring band element to a minimum, but also prevent damage to adjacent parts since the spring band ring no longer has any projecting clamp ends.

The invention intentionally tolerates the apparent disadvantage that the spring band ring of the invention, once installed into the clamped state, cannot be dismounted again, at least not without great effort, i.e., returned to the spread state. The supposed disadvantage even becomes an advantage when for example a connection of two pipe unions is to be broken, the two pipe unions being connected to one another in some other way, for example via a quarter-turn fastener. In this situation, it is intended that the hose ends not be pulled from the pipe unions by releasing the spring band ring, but instead the two pipe unions be separated from one another, i.e., using a quarter-turn fastener. Because the spring band ring of the invention cannot be dismounted, improper dismounting by a mechanic is prevented in this case.

Advantageously, in the spring band ring of the invention, the spring band has an undercut adjacent to each of the clamp ends. One such undercut enables the clamping tool to engage the clamp ends without the clamp ends having to project laterally over the spring band. This embodiment further reduces the amount of installation space required. Preferably, the clamp ends and the undercuts are made such that the clamping tool can engage the clamp ends essentially along the peripheral center line of the spring band. This ensures that the spring band ring, when being spread, is expanded symmetrically relative to the center line so that uniform loading of the spring band is ensured.

It is especially advantageous if a mechanical overextension prevention means is provided which acts between the clamp ends. One such mechanical overextension prevention means of the invention prevents the spring band ring from being spread significantly beyond the allowable spread state. In any embodiment, providing one such mechanical overextension prevention means precludes stretching the spring band ring beyond the permissible spread state and thus prevents possible damage to the spring band ring.

One structurally simple embodiment of the overextension prevention means provides for the clamp ends to each have one projection which is used as a stop and where the two projections face one another. When the spring band ring is spread using a clamping tool, the two projections push against one another so that overextension of the spring band ring is prevented.

According to one preferred embodiment of the invention, the spring band has a cross section which varies over its periphery, i.e., a width which varies over its periphery such that in the direction of the clamp ends the width decreases. As an alternative to varying the width, the spring band ring can undergo material reduction by punching out various window geometries to achieve an optimum, uniform tension state. When the spring band ring is in the clamped state, the greatest stress occurs in the middle area of the spring band opposite the clamp ends. However, a corresponding variation of the cross section of the periphery of the spring band can result in each area of the spring band having essentially the same tension occur. Tension is defined here as the stress normalized onto the surface. Thus, by varying the width of the spring band, the material is optimally used, either by reducing the width, or by material reduction, i.e.., punching out various window geometries, to achieve an optimum uniform tension state of the spring band in the vicinity of the clamp ends. By such techniques, reduction of the weight of the spring band ring can also be achieved. Additionally, it is possible to increase the spring force of the spring band ring by a specific increase in the width of the spring band in the area opposite the clamp ends.

In this preferred embodiment of the invention the spring band of the spring band ring of the invention can be provided with a cross section which varies over its periphery, by punching out the spring band so that windows are formed in the spring band. In doing this, then the window geometries are chosen such that the desirable uniform tension is achieved in the spring band.

### BRIEF DESCRIPTION OF THE DRAWINGS

FIG. 1 shows a spring band ring in the clamped state,

FIG. 2 shows the spring band ring from FIG. 1 in the spread state,

FIG. 3 shows the spring band ring from FIG. 1 in the uncoiled state,

FIG. 4 shows the uncoiled state of another embodiment of a spring band ring of the invention, and

FIG. 5 shows a perspective view of the spring band ring from FIG. 1.

### DETAILED DESCRIPTION OF THE INVENTION

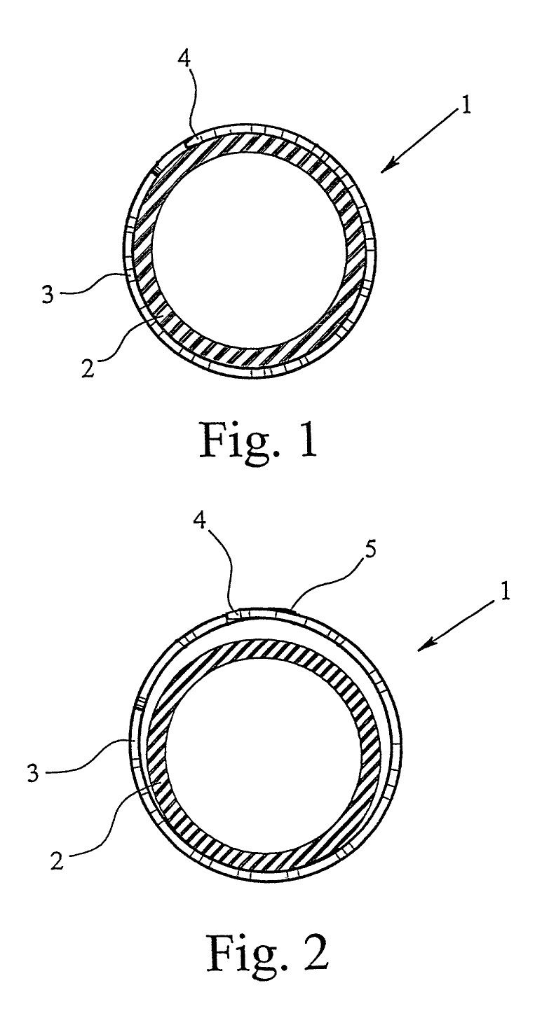

FIG. 1 shows a spring band ring 1 which has been placed on the end 2 of a hose 2. The spring band ring is used for fixed connection of hoses to pipes, branch pieces or plug connections in cooling systems, fuel systems or air lines, especially in the engine compartment of a motor vehicle. The spring band ring 1 includes a spring band 3 which runs essentially annularly and two clamp ends 4, 5 which run essentially in the peripheral direction and which overlap one another. The spring band 3 and the clamp ends 4, 5 are made in one piece so that the clamp ends 4, 5 form the ends of the spring band 3. In the clamping state, which hereinafter is always called the clamped state, the spring band ring 1 has a inside diameter which is somewhat smaller than the outside diameter of the hose end 2 so that the hose end 2 is pressed in a pressure-tight fashion onto a pipe union. It is apparent there that the clamp ends 4, 5, when in the clamped state, do not project radially outward from the round spring band 3. The clamp ends 4, 5 instead extend solely in the peripheral, circumferential direction of the spring band 3 so that the outside dimensions of the spring band 3 essentially correspond to the outside diameter of the hose end 2. The amount of space required for installation of the spring band ring 1 is thus very small. Additionally, damage to adjacent components is prevented by avoiding radially projecting clamp ends.

The spring band 3 can be spread to a second diameter against its own spring force using a clamping tool which is not shown and which can be tongs. This state, which is always called the spread state, is shown in FIG. 2. Adjacent to the clamp ends 4, 5, the spring band 3 has one undercut 6, 7 at each end. The clamp ends 4, 5 and the undercuts 6, 7 are made such that the clamping tool can engage essentially along the peripheral center line 8 of the spring band 3. In order to enable good and safe engagement points when the spring band 3 is being spread by a clamping tool, the end faces of the clamp ends 4, 5 are provided with edges 9 which extend essentially perpendicular to the peripheral center line 8 of the spring band 3. Stressing of the spring band 3, which acts symmetrically to the peripheral center line 8, is supported by these edges 9.

The clamp ends 4, 5, opposite the edges 9, each have a projection 10, 11 which function as an overextension prevention means for the spring band 3. The two projections 10, 11 are arranged facing one another such that, when the spring band ring 1 is spread, the two projections 10, 11 abut one another and thus can prevent overextension of the spring band 3.

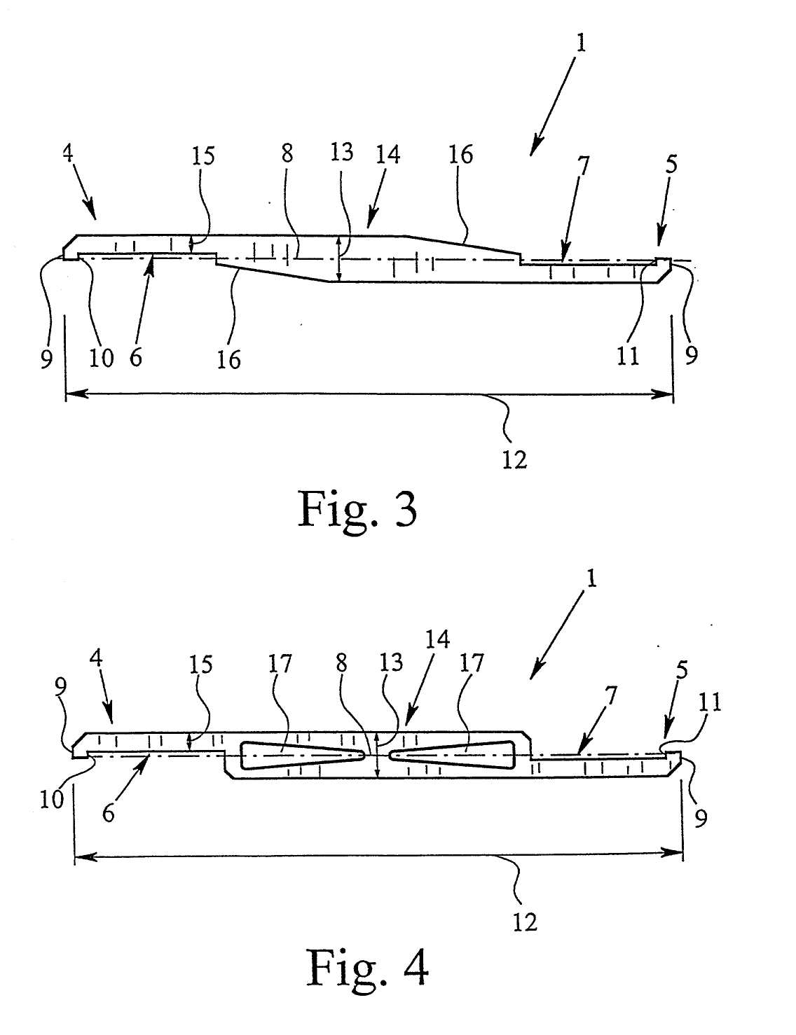

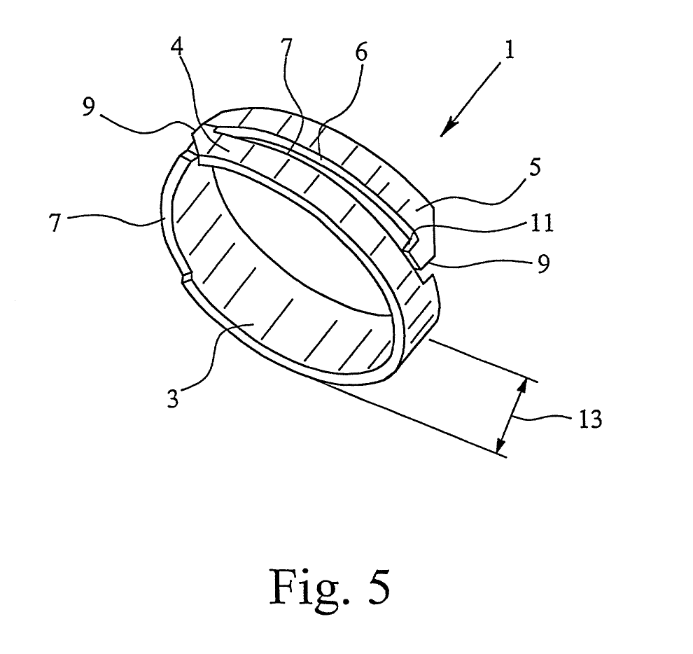

As is apparent from FIG. 3, the spring band 3 in this embodiment has a width 13 which varies along its periphery 12, which in the uncoiled state of the spring band ring 1 corresponds to the length of the spring band 3. The width 13 is shown decreasing in the direction of the clamp ends 4, 5. When being spread and in the clamped state, the bending stress acting on the spring band 3 is greatest in the middle 14 of the spring band 3, i.e. on the area farthest away from the clamp ends 4, 5. Further, in order for the spring band ring 1 to have a given spring force, the spring band 3 in the middle 14 must have a certain width 13. Since the bending stress acting on the spring band 3 decreases as the distance from the middle 14 increases, the width 13 of the spring band 3 can be made less as the distance from the middle 14 increases. Overall, a spring band 3 can thus be constructed in which the available material is optimally used, i.e. in which the tension in each section of the spring band 3 is essentially the same.

The width 15 of the clamp ends 4, 5 is somewhat smaller than half the maximum width 13 of the spring band 3, so that the two clamp ends 4, 5 can be guided past one another when the spring band ring 1 is spread, and so that the total width of the spring band ring 1 is not greater than the maximum width 13 of the spring band 3. Instead of the linear reduction in width 15, shown here via bevels 16, other variations of the width 13 are possible.

In still another embodiment, shown in FIG. 4, the spring band 3 is provided with punchouts 17 which enable the advantages of stress management of the spring band of FIG. 3 to be achieved.

What is claimed is:

1. A spring band element for use in annularly clamping one end of a hose comprising a spring band adapted to exert an inherent spring force and a clamp end at each end of the spring band, wherein the clamp ends circumferentially overlap one another when the spring band is formed into a ring shape, and wherein the spring band has a first diameter when assembled into a clamping state on a hose, and the spring band has a second larger diameter, when the spring band element is spread against said spring force, and wherein
each clamp end is formed such that the clamp ends do not project radially outward from the spring band element in the clamping state.

2. A spring band element as set forth in claim 1, wherein the spring band has an undercut adjacent to each clamp end.

3. A spring band element as set forth in claim 2, wherein each clamp end and the undercuts are constructed such that a clamping tool can engage each clamp end along the center line of the spring band.

4. A spring band element as set forth in claim 1, wherein each clamp end is provided with a means to prevent mechanical overextension of the spring band element upon being spread against its own spring force.

5. A spring band element as set forth in claim 4, wherein each clamp end has a projection adapted to function as a stop to prevent mechanical overextension wherein the projections face each other.

6. A spring band element as set forth in claim 1, wherein the spring band has a cross section which varies along a length of the spring band.

7. A spring band element as set forth in claim 6, wherein the spring band has a width which varies along the length of the spring band wherein the width decreases in the direction towards each clamp end.

8. A spring band element as set forth in claim 1, wherein the width of each clamp end is less than half a maximum width of the spring band.

9. A spring band element as set forth in claim 6, wherein the spring band is provided with punchouts.

10. A spring band element as set forth in claim 9, wherein the punchouts are adapted to provide substantially uniform stress along the length of the spring band when being spread against its own spring force.

11. A spring band element as set forth in claim 9, wherein the punchouts are shaped to have a decreasing width in the lengthwise direction towards a midpoint of the spring band.
